(19) United States
(12) Patent Application Publication
(10) Pub. No.: US 2025/0089753 A1
(43) Pub. Date: Mar. 20, 2025

(54) MOLDED FOOD, METHOD FOR MANUFACTURING THE SAME, AND CONTAINER-PACKED MOLDED FOOD

(71) Applicant: DAIWA CAN COMPANY, Tokyo (JP)

(72) Inventors: Takahiro Saito, Sagamihara-shi (JP); Tsubasa Kondo, Sagamihara-shi (JP)

(73) Assignee: DAIWA CAN COMPANY, Tokyo (JP)

(21) Appl. No.: 18/970,525

(22) Filed: Dec. 5, 2024

Related U.S. Application Data
(63) Continuation of application No. PCT/JP2023/018628, filed on May 18, 2023.

(30) Foreign Application Priority Data
Jun. 14, 2022 (JP) 2022-095862

(51) Int. Cl. A23P 20/20; A23P 30/10

(52) U.S. Cl. CPC A23P 20/20; A23P 30/10

(57) ABSTRACT

A molded food in which portions having different properties are included in a single molded food and the portions are less likely to fall off, and a method for manufacturing the same are provided. The molded food 1A-1 includes a first food portion 11; and a second food portion 12 which includes a first main surface 12A and a second main surface 12B which is a back surface of the first main surface 12A, the first main surface 12A including a first zone 12A1 and a second zone 12A2 adjacent to each other, and which supports the first food portion 11 at a position of the first zone 12A1.

### CROSS-REFERENCE TO RELATED APPLICATIONS

This application is a Continuation Application of PCT Application No. PCT/JP2023/018628, filed May 18, 2023, and based upon and claiming the benefit of priority from Japanese Patent Application No. 2022-095862, filed Jun. 14, 2022, the entire contents of which are incorporated herein by reference.

### BACKGROUND OF THE INVENTION

### 1. Field of the Invention

The present invention relates to a molded food, a method for manufacturing the same, and a container-packed molded food.

### 2. Description of the Related Art

In recent years, mousse-like foods and pasty foods have been distributed as nursing care foods for people with difficulty in chewing or swallowing such as elderly people. Such a food is also referred to as a universal design food (see, for example, Patent Literature 1).

The nursing care foods are classified into four categories according to hardness and the like by the standard of Universal Design Food. Foods in softer categories are often distributed in the form of a mousse-like food directly packed in a container and molded into a container shape, a pasty food made of finely cut or strained food ingredients, or the like.

It is essential to improve the quality of a meal in order to improve the quality of life (QOL) of people with difficulty in chewing or swallowing. Recently, as a nursing care food in consideration of the appearance of food, a molded food obtained by molding a paste raw material obtained by mixing a plurality of food ingredients, seasonings, and the like into a predetermined shape while keeping a soft texture is provided (see, for example, Patent Literature 2 and 3). For example, the quality of a meal for people who eat it has been improved by dishing two or more kinds of these molded foods in one container.

### CITATION LIST

### Patent Literature

Patent Literature 1: Japanese Patent No. 5847295
Patent Literature 2: Jpn. Pat. Appln. KOKAI Publication No. 2021-112184
Patent Literature 3: Jpn. Pat. Appln. KOKAI Publication No. 2021-35345

### SUMMARY OF THE INVENTION

Many foods are made of food ingredients such as plants/animals or seafoods, and even a single food includes portions having different textures such as hardness, and properties such as taste, color, and shape. However, since the conventional molded food described above is obtained by molding a single paste raw material, the appearance such as color and shape inherent in the food ingredient cannot be sufficiently reproduced, and the texture and taste thereof are also monotonous.

If characteristics in which properties such as hardness, taste, color, and shape differ depending on the portion can be imparted to a single molded food, a molded food capable of stimulating five senses of a person who eats it and excellent in reproducibility of a food using food ingredients such as plants/animals or seafoods can be provided. Furthermore, if this molded food can be provided as a soft food conforming to the standard of Universal Design Food, a person having difficulty in chewing or swallowing can enjoy a meal in a form closer to a state of eating a normal food, and the quality of the meal is improved.

An object of the present invention is to provide a molded food in which portions having different properties are included in a single molded food and the portions are less likely to fall off, and a method for manufacturing the same.

According to an aspect of the present invention, there is provided a molded food comprising: a first food portion; and a second food portion which includes a first main surface and a second main surface which is a back surface of the first main surface, the first main surface including a first zone and a second zone adjacent to each other, and which supports the first food portion at a position of the first zone.

According to another aspect of the present invention, there is provided the molded food according to the above aspect, wherein the first main surface includes a recess at the position of the first zone, and at least a part of the first food portion fills the recess and is separated from a side wall of the recess, and a groove is formed at a position of the side wall.

According to still another aspect of the present invention, there is provided the molded food according to the any one of the preceding aspects, wherein at least a part of the first food portion protrudes from the first main surface.

According to still another aspect of the present invention, there is provided the molded food according to any one of preceding aspects, wherein a distance from the second main surface to the first food portion is smaller at a position where a distance from a boundary between the first zone and the second zone is larger than at a position where the distance from the boundary is smaller.

According to still another aspect of the present invention, there is provided the molded food according to any one of the preceding aspects, further comprising an intermediate layer which is interposed between the first food portion and the second food portion and includes a mixture of an ingredient of the first food portion and an ingredient of the second food portion.

According to still another aspect of the present invention, there is provided the molded food according to any one of preceding aspects, wherein a difference between a hardness of the first food portion and a hardness of the second food portion is in a range of 1×10³ N/m² or more and 4.9×10⁴ N/m² or less.

According to still another aspect of the present invention, there is provided the molded food according to any one of the preceding aspects, wherein each of a hardness of the first food portion and a hardness of the second food portion is in a range of 1×10³ N/m² or more and 5×10⁴ N/m² or less.

According to still another aspect of the present invention, there is provided a method for manufacturing a molded food comprising: preparing a molding die which includes a first recess and a second recess each opened upward, an opening of the first recess being provided on a bottom surface of the second recess or between an opening of the second recess and the bottom surface of the second recess; filling the first recess with a first liquid material to a height equal to or less than the opening of the first recess; and filling the second recess with a second liquid material which is different from the first liquid material and covering an upper surface of a layer including the first liquid material with the second liquid material.

According to still another aspect of the present invention, there is provided the method for manufacturing a molded food according to the above aspect, wherein the molding die includes a partition that partitions a bottom portion into a plurality of recesses including the first recess and the second recess.

According to still another aspect of the present invention, there is provided the method for manufacturing a molded food according to any one of the preceding aspects, wherein the second recess includes a first region which is a region above the first recess and a second region which is a region other than the first region, the second liquid material is supplied to the second region to fill the second region with the second liquid material, and a flow of the second liquid material from the second region to the first region is generated to cover the upper surface of the layer including the first liquid material with the second liquid material flowing out of the second region.

According to still another aspect of the present invention, there is provided the method for manufacturing a molded food according to the above aspect, wherein the height of the partition is 3 mm or more and 50% or less of a depth of the molding die.

According to still another aspect of the present invention, there is provided the method for manufacturing a molded food according to any one of the preceding aspects, wherein the opening of the first recess is provided on the bottom surface of the second recess.

According to still another aspect of the present invention, there is provided the method for manufacturing a molded food according to any one of the preceding aspects, further comprising solidifying the layer including the first liquid material and a layer including the second liquid material, wherein filling of the second recess with the second liquid material and covering of the upper surface of the layer including the first liquid material are performed without solidifying the layer including the first liquid material.

According to still another aspect of the present invention, there is provided the method for manufacturing a molded food according to any one of the preceding aspects, wherein at least one of the first liquid material and the second liquid material contains a thickener that dissolves at a temperature in a range of 10° C. or more and 30° C. or less.

According to still another aspect of the present invention, there is provided the method for manufacturing a molded food according to any one of the preceding aspects, wherein at least one of the first liquid material and the second liquid material contains a thickener having pseudoplasticity.

According to still another aspect of the present invention, there is provided a container-packed molded food comprising: a container; and the molded food according to any one of the preceding aspects stored in the container.

According to still another aspect of the present invention, there is provided the container-packed molded food according to the above aspect, further comprising a seasoning liquid stored in the container.

According to the present invention, a molded food in which portions having different properties are included in a single molded food and the portions are less likely to fall off, and a method for manufacturing the same are provided.

### BRIEF DESCRIPTION OF THE DRAWINGS

FIG. 1 is a perspective view illustrating a molded food according to a first embodiment of the present invention.

FIG. 2 is a perspective view illustrating a modification of the molded food according to the first embodiment illustrated in FIG. 1.

FIG. 3 is a perspective view illustrating another modification of the molded food according to the first embodiment illustrated in FIG. 1.

FIG. 4 is a perspective view of a molding die used for manufacturing the molded food according to the first embodiment illustrated in FIG. 1.

FIG. 5 is a perspective view illustrating a first liquid material and a second liquid material supplied to the molding die illustrated in FIG. 4 with the molding die omitted.

FIG. 6 is a perspective view of a molding die used for manufacturing a molded food according to a second embodiment of the present invention.

FIG. 7 is a perspective view illustrating the molded food according to the second embodiment of the present invention manufactured using the molding die illustrated in FIG. 6.

FIG. 8 is a perspective view of a molding die used for manufacturing a molded food according to a third embodiment of the present invention.

FIG. 9 is a perspective view illustrating the molded food according to the third embodiment of the present invention manufactured using the molding die illustrated in FIG. 8.

FIG. 10 is a perspective view of a molding die used for manufacturing a molded food according to a fourth embodiment of the present invention.

FIG. 11 is a perspective view illustrating an example of the molded food according to the fourth embodiment of the present invention manufactured using the molding die illustrated in FIG. 10.

FIG. 12 is a perspective view illustrating another example of the molded food according to the fourth embodiment of the present invention manufactured using the molding die illustrated in FIG. 10.

FIG. 13 is a perspective view of a molding die used for manufacturing a molded food according to a fifth embodiment of the present invention.

FIG. 14 is a perspective view illustrating the molded food according to the fifth embodiment of the present invention manufactured using the molding die illustrated in FIG. 13.

### DESCRIPTION OF THE PREFERRED EMBODIMENTS

Hereinbelow, embodiments of the present invention will be described with reference to the drawings. In each of the embodiments described below, any one of the above aspects is further embodied. The matters described below can be incorporated into each of the aspects alone or in combination of two or more thereof.

In addition, each of the following embodiments exemplifies a configuration for embodying the technical idea of the present invention, and the technical idea of the present invention is not limited by the material, shape, structure, and the like of the following component members. Various modifications can be made to the technical idea of the present invention within the technical scope defined by the claims described in the claims.

Note that elements having equivalent or similar functions are denoted by the same reference signs in the drawings to be referred to below, and redundant description will be omitted. In addition, the drawings are schematic, and a relationship between a dimension in a certain direction and a dimension in another direction, a relationship between a dimension of a certain member and a dimension of another member, and the like may be different from actual ones.

### <1> First Embodiment

FIG. 1 is a perspective view illustrating a molded food according to a first embodiment of the present invention. A molded food 1A-1 illustrated in FIG. 1 includes a first food portion 11 and a second food portion 12. The second food portion 12 has a first main surface 12A and a second main surface 12B which is a back surface of the first main surface 12A. The first main surface 12A includes a first zone 12A1 and a second zone 12A2 adjacent to each other, and supports the first food portion 11 at the position of the first zone 12A1. Here, the first food portion 11 and the second food portion 12 are food compositions different from each other, and are made of a first liquid material and a second liquid material described below, respectively.

In the molded food 1A-1, the first food portion 11 and the second food portion 12 form a multilayer structure by the former being supported by the first zone 12A1 of the latter. That is, the lower surface of the first food portion 11 is in contact with a part of the upper surface of the second food portion 12. This multilayer structure makes it difficult for the first food portion 11 to unintentionally peel off or drop (hereinbelow referred to as “fall off”) from the second food portion 12 before eating the molded food 1A-1, and provides excellent shape maintaining characteristics. For this reason, more options of food ingredients and shapes to be used for the molded food are provided, and reproducibility of the original food imitated by the molded food is improved.

From the viewpoint of making it difficult for the first food portion 11 to fall off, the area of the lower surface of the first food portion 11 is preferably large.

In the molded food 1A-1, the first main surface 12A has a recess at the position of the first zone 12A1, and the first food portion 11 is supported by the second food portion 12 so as to fill the recess. The first food portion 11 filling the recess is separated from the side wall of the recess, and a groove 15 is formed at the position of the side wall.

Due to the presence of the groove 15, the difference in respective properties of the first food portion 11 and the second food portion 12 becomes clearer for the person who eats it. That is, since division of the molded food in the mouth easily occurs at the position of the groove 15, for example, one portion and the other portion separated at the position of the groove 15 can be tasted separately, and thus various textures and tastes can be provided. Also, for example, in a case where one pours a seasoning liquid on the molded food 1A-1 before eating the molded food, the seasoning liquid stays well due to the presence of the groove 15.

The bottom portion of the groove 15 may be located at or below a boundary between the first food portion 11 and the second food portion 12 (that is, the lower surface of the first food portion 11).

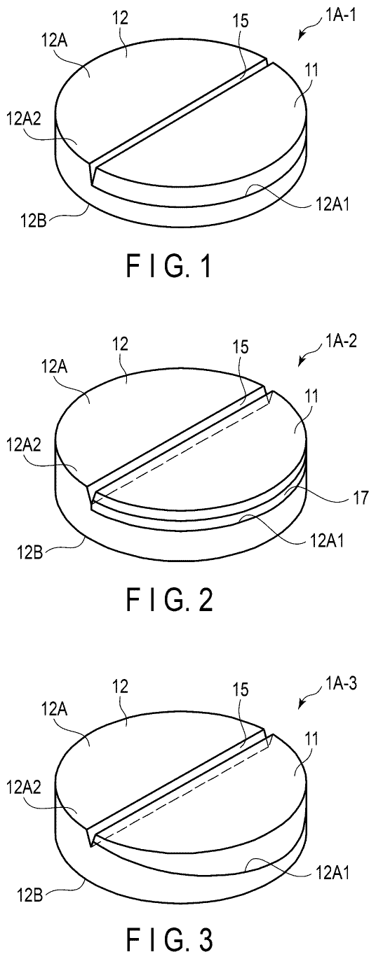

FIG. 2 is a perspective view illustrating a modification of the molded food 1A-1. In a molded food 1A-2 illustrated in FIG. 2, an intermediate layer 17 including a mixture of an ingredient of the first food portion 11 and an ingredient of the second food portion 12 is interposed between a layer including the first food portion 11 and a layer including the second food portion 12. By interposing the intermediate layer 17, the effect of preventing the first food portion 11 from falling off is further improved. As a result, the shape maintaining characteristics of the molded food are further improved, further more options of food ingredients and shapes are provided, and the molded food can imitate the original food with high reproducibility. Note that the intermediate layer 17 includes a material obtained by solidifying a mixture of the first liquid material and the second liquid material described below. As will be described below, the molded food 1A-2 can be manufactured using the same molding die as a molding die used for manufacturing the molded food 1A-1.

FIG. 3 is a perspective view illustrating another modification of the molded food 1A-1. In the molded food 1A-1, the distance from the second main surface 12B of the second food portion 12 to the first food portion 11 is substantially equal over the entire lower surface of the first food portion 11. In a molded food 1A-3 according to the other modification illustrated in FIG. 3, the distance from the second main surface 12B to the first food portion 11 is smaller at a position where the distance from the boundary between the first zone 12A1 and the second zone 12A2 is larger than at a position where the distance from the boundary is smaller. That is, the molded food 1A-3 has a structure in which the thickness of the layer including the first food portion 11 is larger and the thickness of the layer including the second food portion 12 is smaller at a position farther from the boundary and closer to the peripheral edge portion. Such a structure is suitable for reproducing a food ingredient or a food having a structure in which portions having different compositions are arranged in a direction perpendicular to the thickness direction, such as a steak meat having lean meat and fatty meat and a fillet of fish having red flesh or white flesh and skin. As will be described below, the molded food 1A-3 can be manufactured using the same molding die as a molding die used for manufacturing the molded food 1A-1.

The molded food 1A-1 may be a soft food. Here, the “soft food” is a food having a hardness of 6×10⁵ N/m² or less, and preferably a food having a hardness of 5×10⁴ N/m² or less. A method for measuring the hardness of the soft food will be described below.

The first food portion 11 and the second food portion 12 include, for example, different mousse-like foods, respectively. The mousse-like food is a food obtained by pureeing a solid food, preparing a liquid material containing the solid food and a thickener and the like, and molding (solidifying) the liquid material. The solid food can include, for example, meat, fish, vegetables, mushrooms, seaweed, fruits, nuts, grain, or two or more thereof.

In an example, the molded food 1A-1 is a universal design food to be provided as a food for a person with difficulty in swallowing or a food for a person with difficulty in chewing. The universal design food is classified into four categories according to hardness and the like, that is, “easy to chew”, “can be chewed with gums”, “can be broken down with tongue”, and “does not have to be chewed”. Foods belonging to the category “easy to chew” are required to have a hardness of 5×10⁵ N/m² or less, and foods belonging to the category “can be chewed with gums” are required to have a hardness of 5×10⁴ N/m² or less. Foods belonging to the category “can be broken down with tongue” are required to have a hardness of 2×10⁴ N/m² or less in the case of a gel, and to have a hardness of 1×10⁴ N/m² or less in the case of a sol. Foods belonging to the category “does not have to be chewed” are required to have a hardness of 5×10³ N/m² or less in the case of a gel, and to have a hardness of 3×10³ N/m² or less in the case of a sol.

In the molded food 1A-1, each of the hardness of the first food portion 11 and the hardness of the second food portion 12 may be 5×10⁴ N/m² or less classified as the category “can be chewed with gums” according to an example, and may be 2×10⁴ N/m² or less classified as the category “can be broken down with tongue” according to another example. Each of the hardness of the first food portion 11 and the hardness of the second food portion 12 may be 1×10³ N/m² or more according to an example. In a case where the first food portion 11 and the second food portion 12 are too soft, it is difficult for the molded food 1A-1 to maintain its shape.

The hardness of the first food portion 11 and the hardness of the second food portion 12 may be equal to or different from each other. In a case where the first food portion 11 and the second food portion 12 are different in hardness, the first food portion 11 may be harder than the second food portion 12, or the second food portion 12 may be harder than the first food portion 11. According to an example, the second food portion 12 is preferably harder than the first food portion 11.

The difference between the hardness of the first food portion 11 and the hardness of the second food portion 12 is, for example, preferably in a range of 1×10³ N/m² or more and 4.9×10⁴ N/m² or less, and more preferably in a range of 3×10³ N/m² or more and 2×10⁴ N/m² or less. By providing an appropriate difference in hardness, the person who eats the food easily feels the difference in hardness. On the other hand, if the difference in hardness is too large, one of the first food portion 11 and the second food portion 12 is too hard, and thus such a food may not be suitable as a universal design food.

Note that the hardness of the soft food is measured by the following method.

As the measuring apparatus, an apparatus capable of measuring compressive stress of a substance by linear motion is used. A sample is supplied to a height of 15 mm to a container having a diameter of 40 mm, and the sample is compressed by a plunger having a diameter of 20 mm to measure the compressive stress. This measurement is performed at a temperature of 20±2° C., at a compression rate of 10 mm/sec, until the clearance between the bottom surface of the container and the plunger reaches 5 mm. In a case where the sample is in indefinite shape or the like, measurement may be performed by setting the clearance to 30% of the thickness of the sample. This measurement is performed five times, and the average of three values excluding the maximum value and the minimum value is taken as the measured value.

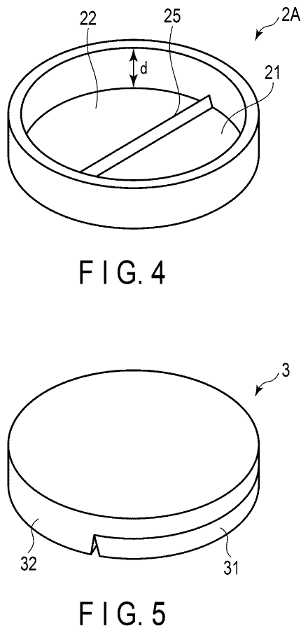

The molded food 1A-1 can be manufactured, for example, by the following method. Description will be provided with reference to FIGS. 4 and 5.

FIG. 4 is a perspective view of a molding die used for manufacturing the molded food 1A-1 illustrated in FIG. 1. A molding die 2A illustrated in FIG. 4 has a first recess 21 and a second recess 22 each opened upward, and the opening of the first recess 21 is provided between the opening of the second recess 22 and the bottom surface of the second recess 22. The molding die 2A includes a partition 25 that partitions the bottom portion into the first recess 21 and the second recess 22.

Specifically, the molding die 2A includes a bottom portion having a disk shape and a cylindrical side wall portion protruding upward from a peripheral edge portion of the bottom portion. The partition 25 is provided on the upper surface of the bottom portion, and divides a lower region of the space surrounded by the bottom portion and the side wall portion into two partial regions. Each of these partial regions has a semicircular shape when observed from the depth direction of the molding die 2A. The first recess 21 corresponds to one of these two partial regions. On the other hand, the second recess 22 corresponds to a region excluding the one partial region in the space surrounded by the bottom portion and the side wall portion.

FIG. 5 is a perspective view illustrating the first liquid material and the second liquid material supplied to the molding die 2A illustrated in FIG. 4 with the molding die 2A omitted. A filler 3 illustrated in FIG. 5 includes a layer (first filling layer) 31 including the first liquid material and a layer (second filling layer) 32 including the second liquid material.

In manufacture of the molded food 1A-1, the molding die 2A illustrated in FIG. 3, and the first liquid material and the second liquid material made of different food compositions, respectively, are used. First, the first recess 21 of the molding die 2A is filled with the first liquid material to a height equal to or less than the height of the opening of the first recess 21, that is, a height equal to or less than the height of the partition 25, thereby forming the layer 31 including the first liquid material. Subsequently, the second liquid material is supplied to the second recess 22 to fill the second recess 22 with the second liquid material, and the upper surface of the layer 31 including the first liquid material is covered with the second liquid material, to form the layer 32 including the second liquid material. Thus, the filler 3 illustrated in FIG. 5 is obtained. In the filler 3, the layer 31 including the first liquid material is solidified to obtain the first food portion 11, and the layer 32 including the second liquid material is solidified to obtain the second food portion 12.

In the above method, after the first recess 21 is filled with the first liquid material, the second liquid material is preferably supplied to the second recess 22 by, for example, the following method. Note that, in the following description, in the second recess 22, a region above the first recess 21 is referred to as a first region, and a region other than the first region is referred to as a second region. In this preferred method, the second liquid material is supplied to the second recess 22 by supplying the second liquid material to the second region. When the second liquid material is supplied to the second region, the second liquid material overflows the lower region of the second region beyond the partition 25 while the second region is being filled with the second liquid material, and a flow of the second liquid material from the second region to the first region is generated. As a result, the upper surface of the layer 31 including the first liquid material is covered with the second liquid material flowing out of the second region. Then, by continuing the supply of the second liquid material to the second region, the entire first region is filled with the second liquid material.

This supply method has the following effects as compared with the case of supplying the second liquid material to the first region of the second recess 22. That is, the stirring effect of the first liquid material included in the first filling layer 31 due to the supply of the second liquid material is small, and it is possible to prevent the first liquid material and the second liquid material from being mixed excessively. This facilitates formation of a multilayer structure including the first filling layer 31 and the second filling layer 32, and further facilitates formation of a multilayer structure in which an intermediate layer including a mixture of the first liquid material and the second liquid material is interposed between these two layers. This means that it is easy to form a multilayer structure including the first food portion 11 and the second food portion 12 in the molded food 1A-1, and it is also easy to form a multilayer structure in which the intermediate layer 17 including the mixture of the ingredient of the first food portion 11 and the ingredient of the second food portion 12 is interposed in the molded food 1A-2 illustrated in FIG. 2 as the modification.

The other modification of the molded food 1A-1 described above, that is, the molded food 1A-3 illustrated in FIG. 3 can be easily formed by the method for supplying the second liquid material to the second recess 22 described here. That is, at the time of supplying the second liquid material to the second region, if the viscosity of the first liquid material forming the first filling layer 31 and the viscosity of the second liquid material are within appropriate ranges, part of the first liquid material located in the vicinity of the partition 25 is swept away to a position away from the partition 25 by the flow of the second liquid material from the second region to the first region. Therefore, the structure can be obtained in which the distance from the second main surface 12B to the first food portion 11 is smaller at a position where the distance from the boundary between the first zone 12A1 and the second zone 12A2 is larger than at a position where the distance from the boundary is smaller.

The difference in distance can be adjusted by, for example, the viscosities of the first liquid material and the second liquid material, the supply rate of the second liquid material, and the like. For example, in a case where the first liquid material has a low viscosity and the second liquid material has a high viscosity, a structure in which the difference in distance is large can be obtained. In a case where the first liquid material has a high viscosity and the second liquid material has a low viscosity, a structure in which the difference in distance is small or zero can be obtained. Also, in a case where the supply rate of the second liquid material is increased, the difference in distance can be increased.

The height of the partition 25 is preferably, for example, 3 mm or more and 50% or less of a depth d of the molding die 2A. In a case where the height of the partition 25 is 3 mm or more, it is easy to adjust the filling amount when the first liquid material is supplied to the height of the partition 25 or less. In addition, in a case where the height of the partition 25 is 50% or less of the depth of the molding die 2A, breakage, collapse, chipping, or the like caused by the groove 15 can be made less likely to occur in the molded food 1A-1. More preferably, the height of the partition 25 is 30% or less of the depth of the molding die 2A. The depth d of the molding die 2A is preferably, for example, 6 mm or more and 100 mm or less.

The first liquid material used for forming the first food portion 11 and the second liquid material used for forming the second food portion 12 are only required to be viscous liquid materials that have a property of being solidified by heating, cooling, or the like. The first liquid material and the second liquid material each contain, for example, a raw material and another component such as a thickener.

Examples of the raw material include a component obtained by pureeing a solid food. The solid food can include, for example, meat, fish, vegetables, mushrooms, seaweed, fruits, nuts, grain, or two or more thereof. The solid food may be a food ingredient before cooking or may be a cooked food. In the latter case, the solid food may further contain one or more of fats and oils and seasonings such as sugar and salt.

The solid food is preferably pureed until the particle diameter becomes sufficiently small. The smaller the particle diameter, the smoother the texture. The particle diameter of the pureed food is preferably 2.0 mm or less, more preferably 0.5 mm or less, and still more preferably 0.1 mm or less. Here, the “particle diameter” is a value obtained by particle size distribution measurement by means of a laser diffraction scattering method.

The first liquid material and the second liquid material each contain, for example, a thickener as another component. The fact that the first liquid material and the second liquid material are viscous liquid materials having appropriate viscosities is important in forming a multilayer structure including the first filling layer 31 and the second filling layer 32 that the filler 3 has. That is, in a case where the viscosity of the first liquid material and the viscosity of the second liquid material are low, excessive mixing of the first liquid material and the second liquid material may occur, and the filler 3 having the multilayer structure described above may not be obtained. The viscosity of each of the first liquid material and the second liquid material is preferably, for example, 0.5 Pa·s or more. From a similar viewpoint, the viscosity of the first liquid material is preferably higher than the viscosity of the second liquid material, or the first liquid material preferably contains a thickener having pseudoplasticity described below.

On the other hand, in a case where the first liquid material and the second liquid material have high viscosities at the time of filling the molding die 2A, inconvenience such as insufficient spread of the liquid material in the molding die 2A at the time of filling tends to occur. The viscosity of each of the first liquid material and the second liquid material is preferably, for example, (10) Pa·s or less.

Note that the viscosity of the liquid material is expressed as a value in Pas, which is obtained by using a B-type rotational viscometer under a measurement temperature of 20±2° C., rotating the M3 rotor at 12 rpm, reading the value two minutes after this rotation, and multiplying the value by a corresponding coefficient.

Examples of the thickener include, but are not limited to, xanthan gum, guar gum, carboxymethylcellulose, lambda carrageenan, sodium alginate, tamarind seed gum, karaya gum, pectin, pullulan, glucomannan, gum arabic, tamarind gum, carrageenan, tara gum, locust bean gum, curdlan, psyllium seed gum, gellan gum, chitin, chitosan, arabino galactan, welan gum, sesbania gum, aloe vera extract, dammar resin, gum ghatti, elemi resin, dextran, oligoglucosamine, tororoaoi, microfibrillated cellulose, tragacanth gum, bacillus natto gum, hukuronori extract, furcellaran, cassia gum, macrophomopsis gum, kidachi aloe extract, peach gum, aureobasidium cultured solution, enzymatically hydrolyzed guar gum, rhamsan gum, glucosamine, levan, agrobacterium succinoglycan, yeast cell membrane, linseed gum, artemisia sphaeroc ephala seed gum, almond gum, sclero gum, or two or more thereof.

As the thickener, at least one of the first liquid material and the second liquid material preferably contains a thickener that dissolves at a temperature in the range of 10° C. or more and 30° C. or less. When the temperature of the liquid material is in the range of 10° C. or more and 30° C. or less, the contained components are stabilized, and thus the thickener which dissolves in this temperature range is preferable. In particular, at least one of the first liquid material and the second liquid material preferably contains xanthan gum, guar gum, carboxymethylcellulose, lambda carrageenan, sodium alginate, tamarind seed gum, karaya gum, pectin, pullulan, glucomannan, gum arabic, or two or more thereof, and both the first liquid material and the second liquid material more preferably contain one or two or more of these thickeners.

As the thickener, at least one of the first liquid material and the second liquid material preferably contains a thickener having pseudoplasticity, and more preferably contains at least one of xanthan gum and guar gum. In a case where a thickener having pseudoplasticity is used, a property that the viscosity of a liquid material decreases when pressure or the like is applied to the liquid material is imparted. That is, the viscosity is low at the time of supplying the liquid material, but the viscosity increases after the supply. Hence, when the liquid material is pumped up or when the liquid material is discharged from a nozzle and supplied, an appropriate production rate is achieved due to a viscosity decrease, and after the supply, a multilayer structure is easily formed due to a viscosity increase. From the viewpoint of facilitating the formation of the multilayer structure, at least the first liquid material preferably contains a thickener having pseudoplasticity as described above.

The first liquid material and the second liquid material may further contain a gelling agent, a coagulant, a seasoning, water, a food colour, and the like as other components than the thickener. Examples of the gelling agent include, but are not limited to, agar, gelatin, thickening polysaccharides, or two or more thereof.

The coagulant may be, for example, a protein that is thermally denatured and irreversibly solidified by heating. Such a protein is mixed with the pureed raw material, for example, in the form of an aqueous solution. As the protein or the aqueous solution thereof, for example, egg white can be used.

The method for manufacturing the molded food 1A-1 usually includes solidifying the layer (first filling layer) 31 including the first liquid material and the layer (second filling layer) 32 including the second liquid material. The solidification may be performed immediately after the first liquid material is supplied and immediately after the second liquid material is supplied, or may be performed collectively after the first liquid material and the second liquid material are supplied, but the latter is preferable in consideration of the following advantages.

That is, the second liquid material is supplied to the second recess 22 (preferably, the second region) without solidifying the first filling layer 31. The solidification is performed for the first time after the second recess 22 (second region) is filled with the second liquid material, and the upper surface of the first filling layer 31 is covered to fill the second recess 22. Advantages of this include that higher production efficiency can be achieved, that the intermediate layer is formed, so that unintentional drop of the first food portion 11 is less likely to occur in the molded food 1A-1, and that the layers constituting the multilayer structure included in the molded food 1A-1 can have various thicknesses.

The solidification can be performed using a known method. Examples of the solidification method include, but are not particularly limited to, a heating treatment and a cooling treatment.

As the heating treatment, a heating method usually performed in the field of processed foods can be used, and examples thereof include steaming and boiling. These treatments can be performed by conventional methods in the field of processed foods. In a case where the first liquid material and the second liquid material are liquid materials to be solidified by heating, the molded food 1A-1 can be obtained after the heating treatment, but may further be subjected to the cooling treatment.

In a case where the first liquid material and the second liquid material are liquid materials to be solidified by cooling or freezing, the molded food 1A-1 can be obtained by subjecting the first liquid material and the second liquid material to the cooling treatment. Note that a molded food having a different appearance can be obtained by using, for example, another molding die described below instead of the molding die 2A.

The molded food 1A-1 molded by solidification may be sealed by closing the opening with a lid without being released from the molding die 2A, and may be distributed as a container-packed molded food. In this case, the “container” in the “container-packed molded food” means the molding die 2A in which the opening is closed with a lid and sealed.

Alternatively, the molded food 1A-1 molded by solidification may be released from the molding die 2A, stored in a different container from the molding die 2A, and distributed as a container-packed molded food. The form of the container is not limited to a particular one, and may be, for example, a form in which the opening of a cup-shaped container main body is closed with a lid to be sealed, a four-side seal bag provided with a notch as an easy-to-open structure, or another bag such as a three-side seal bag and a gusset bag.

The container-packed molded food can be distributed in a form in which the molded food 1A-1 is stored alone in the container. Alternatively, the container-packed molded food can be distributed in a form in which the molded food 1A-1 and another edible food such as a seasoning liquid are stored in the container.

In a case where the container-packed molded food stores the molded food 1A-1 and the seasoning liquid in the container, the molded food 1A-1 and the seasoning liquid may be stored in a mixed state according to an example.

According to an example, the seasoning liquid is a liquid containing water, a seasoning, an extract of an animal food ingredient, an extract of a plant food ingredient, or a combination thereof. The seasoning liquid is, for example, a solution, a dispersion liquid such as a sol, or a combination thereof.

The seasoning liquid can further contain a thickener. Examples of the thickener are the same as the examples of the thickener described above for the first liquid material and the second liquid material.

The seasoning liquid may further contain a gelling agent. Examples of the gelling agent are the same as the examples of the gelling agent described above for the first liquid material and the second liquid material.

The viscosity of the seasoning liquid is preferably in the range of 0.5 to 20.0 Pa·s, more preferably in the range of 0.5 to 10.0 Pas, and still more preferably in the range of 1.5 to 2.0 Pas. The solution or sol belonging to the above category “can be broken down with tongue” or “does not have to be chewed” is required to have a viscosity of 1.5 Pa·s or more.

Note that a method for measuring the viscosity of the seasoning liquid is similar to the viscosity measurement method described above for the first liquid material and the second liquid material.

### <2> Second Embodiment

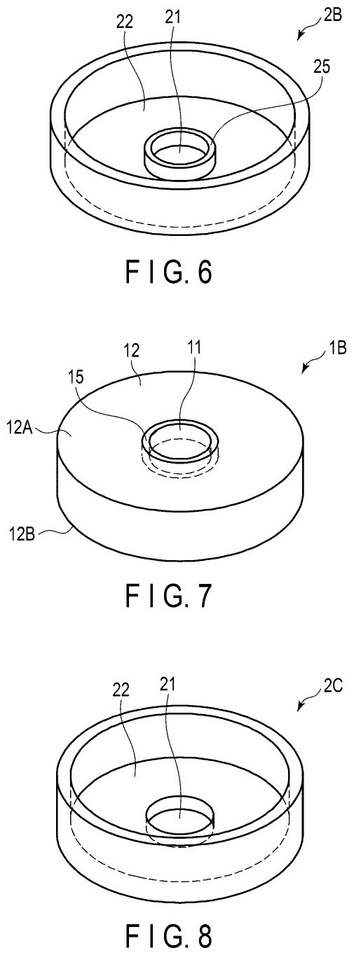

FIG. 6 is a perspective view of a molding die used for manufacturing a molded food according to a second embodiment of the present invention.

A molding die 2B illustrated in FIG. 6 is similar to the molding die 2A except that a partition 25 has a cylindrical shape and is provided at the center of the bottom portion.

FIG. 7 is a perspective view illustrating a molded food according to the second embodiment of the present invention manufactured using the molding die 2B illustrated in FIG. 6.

A molded food 1B according to the second embodiment illustrated in FIG. 7 can be manufactured by a similar method to that described above for the molded food 1A-1 in the first embodiment except that the molding die 2B is used instead of the molding die 2A. The molded food 1B is similar to the molded food 1A-1 except that a recess of a first main surface 12A has a cylindrical shape and is provided at the center portion.

Similarly to the molded food 1A-1, the molded food 1B has a multilayer structure in which the lower surface of a first food portion 11 is supported by a second food portion 12, and the first food portion 11 is thus less likely to fall off. For this reason, more options of food ingredients and shapes to be used for the molded food are provided, and reproducibility of the food is excellent.

Further, in a method for manufacturing the molded food 1B, similarly to the method for manufacturing the molded food 1A-1, after a first recess 21 is filled with a first liquid material, a second liquid material is supplied to the second region of a second recess 22 to fill the second recess 22 with the second liquid material, and solidification is performed collectively, whereby the molded food having excellent food reproducibility can be manufactured at high production efficiency.

Note that the supply of the second liquid material to the second region of the second recess 22 may be performed using three or more nozzles that uniformly discharge the second liquid material toward the periphery of the partition 25. In this case, in a case where the viscosities of the first liquid material and the second liquid material and the supply rate of the second liquid material are appropriately set, it is possible to obtain the molded food 1B having a structure in which the center portion of the lower surface of the first food portion 11 protrudes downward.

### <3> Third Embodiment

FIG. 8 is a perspective view of a molding die used for manufacturing a molded food according to a third embodiment of the present invention.

A molding die 2C illustrated in FIG. 8 is similar to the molding die 2A except that the following configuration is employed. That is, in the molding die 2C, the opening of a first recess 21 is provided at the bottom portion of a second recess 22, and no partition is provided that partitions the bottom portion into the first recess 21 and the second recess 22.

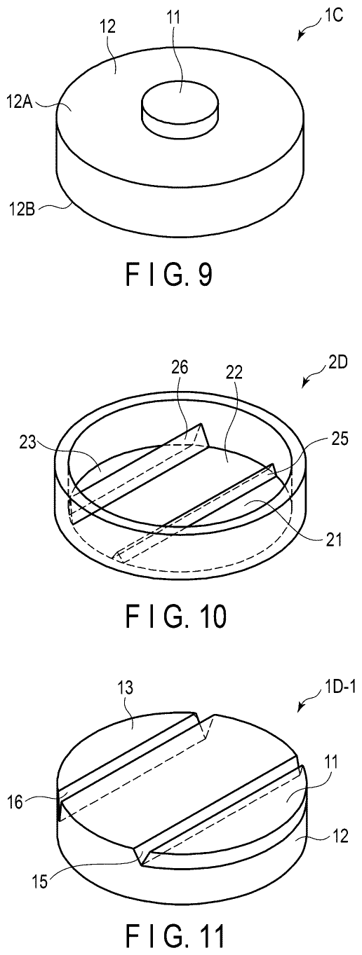

FIG. 9 is a perspective view illustrating a molded food according to the third embodiment of the present invention manufactured using the molding die 2C illustrated in FIG. 8.

A molded food 1C according to the third embodiment illustrated in FIG. 9 can be manufactured by a similar method to that described above for the molded food 1A-1 in the first embodiment except that the molding die 2C is used instead of the molding die 2A. In the molded food 1C, a first food portion 11 protrudes from a first main surface 12A of a second food portion 12. Unlike the molded food 1A-1, the first food portion 11 is not buried in the recess of the second food portion 12. Therefore, the molded food 1C does not include a groove 15 formed by the first food portion 11 being separated from the side wall of the recess.

Similarly to the molded food 1A-1, the molded food 1C has a multilayer structure in which the lower surface of the first food portion 11 is supported by the second food portion 12, and the first food portion 11 is thus less likely to fall off. For this reason, more options of food ingredients and shapes to be used for the molded food are provided, and reproducibility of the food is excellent.

As for the molded food 1C, similarly to the method for manufacturing the molded food 1A-1, after a first recess 21 is filled with a first liquid material, a second liquid material is supplied to the second region of a second recess 22 to fill the second recess 22 with the second liquid material, and solidification is performed collectively, whereby the molded food having excellent food reproducibility can be manufactured at high production efficiency.

The molded food 1C is, in an example, a fried egg like molded food. By using the above method as a method of supplying the second liquid material to the second recess 22 for the egg white portion and adjusting the viscosities of the first liquid material and the second liquid material, the supply rate of the second liquid material, the positions and number of nozzles for supplying the second liquid material, and the like, a fried egg like molded food is obtained in which the center portion of the first food portion 11 as the yolk portion swells to the side of the second food portion 12 provided with a second main surface 12B and in which the center portion of the yolk portion is thicker in thickness than the peripheral edge portion thereof.

### <4> Fourth Embodiment

FIG. 10 is a perspective view of a molding die used for manufacturing a molded food according to a fourth embodiment of the present invention.

A molding die 2D illustrated in FIG. 10 has a first recess 21, a second recess 22, and a third recess 23, each of which is opened upward. The molding die 2D is similar to the molding die 2A except that the molding die 2D further includes a partition 26. The partition 26, together with a partition 25, partitions the bottom portion into the first recess 21, the second recess 22, and the third recess 23.

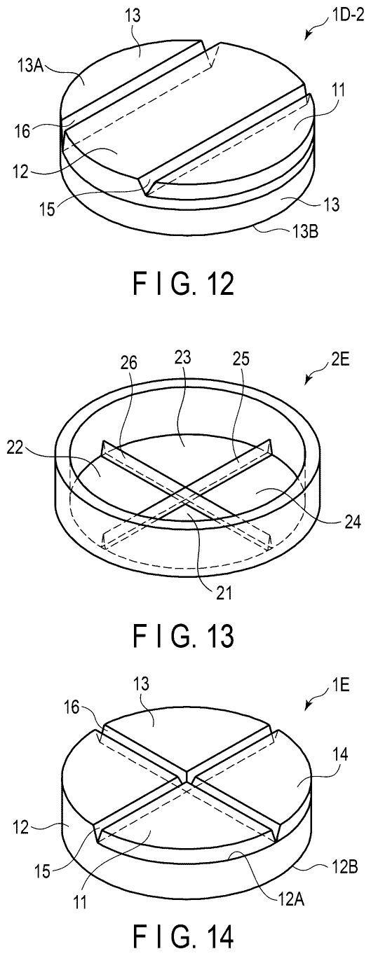

Here, the height of the partition 26 is freely selected in a case where the molding die 2D is used for manufacturing a molded food 1D-1 illustrated in FIG. 11 described below. In this case, similarly to the case of the partition 25, the height of the partition 26 is preferably 3 mm or more and 50% or less of a depth d of the molding die 2D, and more preferably 3 mm or more and 30% or less of the depth of the molding die 2D. On the other hand, in a case where the molding die 2D is used for manufacturing a molded food 1D-2 illustrated in FIG. 12 described below, the height of the partition 26 needs to be higher than the height of the partition 25. In this case, the height of the partition 26 is preferably, for example, 1 mm or more higher than that of the partition 25 and 50% or less of the depth d of the molding die 2D.

FIG. 11 is a perspective view illustrating an example of a molded food according to the fourth embodiment of the present invention manufactured using the molding die 2D illustrated in FIG. 10.

The molded food 1D-1 illustrated in FIG. 11 is similar to the molded food 1A-1 except that the molded food 1D-1 has the following structure. That is, the molded food 1D-1 further includes a third food portion 13. A first main surface 12A of a second food portion 12 further includes a recess in which a third food portion 13 is buried (hereinbelow, the recess is also referred to as a “third food portion recess”) as well as a recess in which a first food portion 11 is buried (hereinbelow, the recess is also referred to as a “first food portion recess”). The lower surface of the third food portion 13 is supported by the second food portion 12. The third food portion 13 is separated from the side wall of the third food portion recess, and a groove 16 is formed at the position of the side wall.

Similarly to the molded food 1A-1, the molded food 1D-1 has a multilayer structure in which the lower surfaces of the first food portion 11 and the third food portion 13 are supported by the second food portion 12, and the first food portion 11 and the third food portion 13 are thus less likely to fall off. For this reason, more options of food ingredients and shapes to be used for the molded food are provided, and reproducibility of the food is excellent.

The molded food 1D-1 can be manufactured by a similar method to the method for manufacturing the molded food 1A-1 except for the following points.

That is, in manufacture of the molded food 1D-1, a third liquid material is used in addition to a first liquid material and a second liquid material. The layer obtained by solidifying the third liquid material is the third food portion 13, and the third liquid material is different from the second liquid material, and may be the same as or different from the first liquid material. A method for manufacturing the molded food 1D-1 further includes filling the third recess 23 with the third liquid material to a height equal to or less than the height of the opening of the third recess 23, that is, a height equal to or less than the height of the partition 26. This process may be performed before filling the first recess 21 with the first liquid material or after filling the first recess 21 with the first liquid material as long as it is before filling the second recess 22 with the second liquid material.

After the first recess 21 is filled with the first liquid material and the third recess 23 is filled with the third liquid material, the second liquid material is supplied to the second recess 22 to fill the second recess 22 with the second liquid material, and the upper surface of the layer including the first liquid material and the upper surface of the layer including the third liquid material are covered with the second liquid material.

Here, the second liquid material is preferably supplied to the second recess 22 by, for example, the following method. That is, in a case where the second recess 22 is divided into a first region that is the upper portion of the first recess 21, a third A region that is the upper portion of the third recess 23, and a second A region that is the region other than the first region and the third A region, the second liquid material is supplied to the second recess 22 by being supplied to the second A region. In this case, while the second liquid material is being supplied to the second A region, the upper surfaces of the layer including the first liquid material and the layer including the third liquid material are covered with the second liquid material overflowing the second A region, and the second recess 22 is filled with the second liquid material.

In the method for manufacturing the molded food 1D-1, by performing solidification collectively, the molded food having excellent food reproducibility can be manufactured at high production efficiency.

FIG. 12 is a perspective view illustrating another example of a molded food according to the fourth embodiment of the present invention manufactured using the molding die 2D illustrated in FIG. 10.

The molded food 1D-2 illustrated in FIG. 12 is similar to the molded food 1A-1 except that the molded food 1D-2 has the following structure. That is, the molded food 1D-2 further includes a third food portion 13. The third food portion 13 has a first main surface 13A and a second main surface 13B which is a back surface of the first main surface 13A. The first main surface 13A has a recess, and the lower surface of a second food portion 12 is supported by the third food portion 13 so as to fill the recess (hereinbelow, the recess is also referred to as a “second food portion recess”). The second food portion 12 is separated from the side wall of the second food portion recess, and a groove 16 is formed at the position of the side wall.

Since the molded food 1D-2 has a multilayer structure in which the lower surface of the first food portion 11 is supported by the second food portion 12 and the lower surface of the second food portion 12 is supported by the third food portion 13, unintentional falling of the respective food portions is less likely to occur before eating. For this reason, more options of food ingredients and shapes to be used for the molded food are provided, and reproducibility of the food is excellent.

The molded food 1D-2 can be manufactured, for example, by the following method.

That is, in manufacture of the molded food 1D-2, a third liquid material is used in addition to a first liquid material and a second liquid material. The layer obtained by solidifying the third liquid material is the third food portion 13, and the third liquid material is different from the second liquid material, and may be the same as or different from the first liquid material.

In the method for manufacturing the molded food 1D-2, filling of the first recess 21 with the first liquid material, filling of the second recess 22 with the second liquid material, and filling of the third recess 23 with the third liquid material are performed in this order.

First, the first recess 21 is filled with the first liquid portion by a similar method to that for the molded food 1A-1. Subsequently, the second liquid material is supplied to the second recess 22 to a height equal to or less than the height of the opening of the second recess 22, that is, a height equal to or less than the height of the partition 26, to fill the second recess 22 with the second liquid material, and the upper surface of the layer including the first liquid material is covered with the second liquid material. Subsequently, the third liquid material is supplied to the third recess 23 to fill the third recess 23 with the third liquid material, and the upper surface of the layer including the second liquid material is covered with the third liquid material. Thus, a multilayer structure is obtained.

Here, the supply of the second liquid material to the second recess 22 and the supply of the third liquid material to the third recess 23 are preferably performed, for example, by the following method.

That is, in a case where the third recess 23 is divided into a first region that is the upper portion of the first recess 21, a second B region that is the upper portion of the second recess 22, and a third B region that is the region other than the first region and the second B region, the second liquid material is supplied to the second recess 22 by being supplied to the second B region. In this case, while the second liquid material is being supplied to the second B region, the upper surface of the layer including the first liquid material is covered with the second liquid material overflowing the second B region, and the second recess 22 is filled with the second liquid material.

Further, the third recess 23 is filled with the third liquid material by supplying the third liquid material to the third B region. In this case, while the third liquid material is being supplied to the third B region, the third recess 23 is filled, and the upper surface of the layer including the second liquid material is covered with the third liquid material overflowing the third B region.

In the method for manufacturing the molded food 1D-2, by performing solidification collectively, the molded food having excellent food reproducibility can be manufactured at high production efficiency.

### <5> Fifth Embodiment

FIG. 13 is a perspective view of a molding die used for manufacturing a molded food according to a fifth embodiment of the present invention.

A molding die 2E illustrated in FIG. 13 has a first recess 21, a second recess 22, a third recess 23, and a fourth recess 24, each of which is opened upward. The molding die 2E is similar to the molding die 2A except that the molding die 2E includes a partition 26 that intersects with a partition 25 that partitions the bottom portion into the first recess 21 and the second recess 22 to further partition the bottom portion into the third recess 23 and the fourth recess 24. In the molding die 2E, the partition 25 and the partition 26 have the same height.

FIG. 14 is a perspective view illustrating an example of a molded food according to the fifth embodiment of the present invention manufactured using the molding die 2E illustrated in FIG. 13.

A molded food 1E illustrated in FIG. 14 is similar to the molded food 1A-1 except that the molded food 1E further includes a third food portion 13 and a fourth food portion 14. The recess that a second food portion 12 has on a first main surface 12A is filled with not only a first food portion 11. A part of the recess is filled with the first food portion 11, another part of the recess is filled with the third food portion 13, and the rest of the recess is filled with the fourth food portion 14. The lower surfaces of the third food portion 13 and the fourth food portion 14 are supported by the second food portion 12. The third food portion 13 and the fourth food portion 14 are separated from each other by a groove 15, and the second food portion 12 and the third food portion 13, and the first food portion 11 and the fourth food portion 14 are separated from each other by a groove 16.

Similarly to the molded food 1A-1, the molded food 1E has a multilayer structure in which the lower surfaces of the first food portion 11, the third food portion 13, and the fourth food portion 14 are supported by the second food portion 12, and the first food portion 11, the third food portion 13, and the fourth food portion 14 are thus less likely to fall off before eating. For this reason, more options of food ingredients and shapes to be used for the molded food are provided, and reproducibility of the food is excellent.

The molded food 1E can be manufactured by a similar method to the method for manufacturing the molded food 1A-1 except for the following points.

That is, in manufacture of the molded food 1E, a third liquid material and a fourth liquid material are used in addition to a first liquid material and a second liquid material. The layer obtained by solidifying the third liquid material is the third & food portion 13, and the layer obtained by solidifying the fourth liquid material is the fourth food portion 14. The third liquid material and the fourth liquid material are different from the second liquid material. The first liquid material, the third liquid material, and the fourth liquid material may be the same or different from each other.

The first recess 21, the third recess 23, and the fourth recess 24 of the molding die 2E are filled with the first liquid material, the third liquid material, and the fourth liquid material, respectively. The order of these processes is freely selected as long as it is before filling the second recess 22 with the second liquid material.

Subsequently, the second recess 22 is filled with the second liquid material, and the upper surfaces of the layer including the first liquid material, the layer including the third liquid material, and the layer including the fourth liquid material are covered with the second liquid material. Thus, a multilayer structure is obtained.

Here, the second liquid material is preferably supplied to the second recess 22 by, for example, the following method. That is, in a case where the second recess 22 is divided into a first region that is the upper portion of the first recess 21, a third region that is the upper portion of the third recess 23, a fourth region that is the upper portion of the fourth recess 24, and a second C region that is the region other than the first region, the third region, and the fourth region, the second liquid material is supplied to the second recess 22 by being supplied to the second C region. In this case, while the second liquid material is being supplied to the second C region, the upper surfaces of the layer including the first liquid material, the layer including the third liquid material, and the layer including the fourth liquid material are covered with the second liquid material overflowing the second C region, and the second recess 22 is filled with the second liquid material.

In the method for manufacturing the molded food 1E, by performing solidification collectively, the molded food having excellent food reproducibility can be manufactured at high production efficiency.

Note that the present invention is not limited to the above embodiments, and various modifications can be made in the implementation stage without departing from the gist thereof. In addition, the embodiments may be implemented in appropriate combination, and in that case, a combined effect can be obtained. Furthermore, the above-described embodiments include various inventions, and various inventions can be extracted by a combination selected from a plurality of disclosed components. For example, in a case where the problem can be solved and the effect can be obtained even in a case where some components are removed from all the components illustrated in the embodiment, a configuration obtained by removing the components can be extracted as the invention.

### REFERENCE SIGNS LIST

1A-1 Molded food
1A-2 Molded food
1A-3 Molded food
1B Molded food
1C Molded food
1D-1 Molded food
1D-2 Molded food
1E Molded food
2A Molding die
2B Molding die
2C Molding die
2D Molding die
2E Molding die
3 Filler
11 First food portion
12 Second food portion
13 Third food portion
14 Fourth food portion
15 Groove
16 Groove
21 First recess
22 Second recess
23 Third recess
24 Fourth recess
25 Partition
26 Partition
31 Layer including first liquid material (first filling layer)
32 Layer including second liquid material (second filling layer)
d Depth of molding die

What is claimed is:

1. A molded food comprising:
a first food portion; and
a second food portion which includes a first main surface and a second main surface which is a back surface of the first main surface, the first main surface including a first zone and a second zone adjacent to each other, and which supports the first food portion at a position of the first zone.

2. The molded food according to claim 1, wherein the first main surface includes a recess at the position of the first zone, and at least a part of the first food portion fills the recess and is separated from a side wall of the recess, and a groove is formed at a position of the side wall.

3. The molded food according to claim 1, wherein at least a part of the first food portion protrudes from the first main surface.

4. The molded food according to claim 1, wherein a distance from the second main surface to the first food portion is smaller at a position where a distance from a boundary between the first zone and the second zone is larger than at a position where the distance from the boundary is smaller.

5. The molded food according to claim 1, further comprising an intermediate layer which is interposed between the first food portion and the second food portion and includes a mixture of an ingredient of the first food portion and an ingredient of the second food portion.

6. The molded food according to claim 1, wherein a difference between a hardness of the first food portion and a hardness of the second food portion is in a range of 1×10³ N/m² or more and 4.9×10⁴ N/m² or less.

7. The molded food according to claim 1, wherein each of a hardness of the first food portion and a hardness of the second food portion is in a range of 1×10³ N/m² or more and 5×10⁴ N/m² or less.

8. A method for manufacturing a molded food comprising:
preparing a molding die which includes a first recess and a second recess each opened upward, an opening of the first recess being provided on a bottom surface of the second recess or between an opening of the second recess and the bottom surface of the second recess;
filling the first recess with a first liquid material to a height equal to or less than the opening of the first recess; and
filling the second recess with a second liquid material which is different from the first liquid material and covering an upper surface of a layer including the first liquid material with the second liquid material.

9. The method for manufacturing a molded food according to claim 8, wherein the molding die includes a partition that partitions a bottom portion into a plurality of recesses including the first recess and the second recess.

10. The method for manufacturing a molded food according to claim 8, wherein the second recess includes a first region which is a region above the first recess and a second region which is a region other than the first region, the second liquid material is supplied to the second region to fill the second region with the second liquid material, and a flow of the second liquid material from the second region to the first region is generated to cover the upper surface of the layer including the first liquid material with the second liquid material flowing out of the second region.

11. The method for manufacturing a molded food according to claim 9, wherein the height of the partition is 3 mm or more and 50% or less of a depth of the molding die.

12. The method for manufacturing a molded food according to claim 8, wherein the opening of the first recess is provided on the bottom surface of the second recess.

13. The method for manufacturing a molded food according to claim 8, further comprising solidifying the layer including the first liquid material and a layer including the second liquid material,
wherein filling of the second recess with the second liquid material and covering of the upper surface of the layer including the first liquid material are performed without solidifying the layer including the first liquid material.

14. The method for manufacturing a molded food according to claim 8, wherein at least one of the first liquid material and the second liquid material contains a thickener that dissolves at a temperature in a range of 10° C. or more and 30° C. or less.

15. The method for manufacturing a molded food according to claim 8, wherein at least one of the first liquid material and the second liquid material contains a thickener having pseudoplasticity.

16. A container-packed molded food comprising: a container; and the molded food according to claim 1 stored in the container.

17. The container-packed molded food according to claim 16, further comprising a seasoning liquid stored in the container.
